(19) United States
(12) Patent Application Publication
(10) Pub. No.: US 2013/0252456 A1
(43) Pub. Date: Sep. 26, 2013

(54) Securing a Field Replaceable Unit

(71) Applicants: Joseph Kuczynski, Rochester, MN (US); Robert E. Meyer, III, Rochester, MN (US); Mark D. Plucinski, Rochester, MN (US); Timothy J. Tofil, Rochester, MN (US)

(72) Inventors: Joseph Kuczynski, Rochester, MN (US); Robert E. Meyer, III, Rochester, MN (US); Mark D. Plucinski, Rochester, MN (US); Timothy J. Tofil, Rochester, MN (US)

(73) Assignee: INTERNATIONAL BUSINESS MACHINES CORPORATION, Armonk, NY (US)

(21) Appl. No.: 13/424,497

(22) Filed: Mar. 20, 2012

(51) Int. Cl. H01R 13/62; B32B 37/04

(52) U.S. Cl. 439/371; 156/293

(57) ABSTRACT

An assembly may have first and second components. The first component may include a first electrical connector and a guide member. The second component may include a second electrical connector to couple with the first electrical connector, and a receptacle to receive the guide member in a mated position. An adhesive may be provided between the guide member and the receptacle to form a bond between the guide member and the receptacle. The bond may be reversed when the adhesive is heated above a threshold temperature. A heating element to heat the adhesive may be provided.

### TECHNICAL FIELD

The field of the invention relates generally to computer systems, and more specifically, to securing field replaceable units within computer systems.

### BACKGROUND

A typical computer system used in the electronics industry today includes one or more field replaceable units (FRUs). An FRU may be a circuit board, part, or assembly. An FRU may be docked to a backplane or motherboard of a chassis or rack contained within a computer system such as a personal computer, server, or other piece of electronic equipment. Generally, FRUs can be quickly and easily removed from the computer system and replaced by the user or a technician without having to send the entire computer system to a repair facility. A common manufacturing strategy is to install the FRUs, conduct a test of the computer system, and then package it for shipping to a customer.

### SUMMARY

According to embodiments of the invention, an assembly having first and second components may be provided. The first component may include a first electrical connector and a guide member. The second component may include a second electrical connector to couple with the first electrical connector, and a receptacle to receive the guide member in a mated position. The assembly may have an adhesive between the guide member and the receptacle to form a bond between the guide member and the receptacle. The bond may be reversed when the adhesive is heated above a threshold temperature. In one embodiment, a heating element to heat the adhesive may be provided.

According to other embodiments, a method may be provided for mating a first component with a second component. The first component may have a first electrical connector and a guide member. The second component may have a second electrical connector and a receptacle to receive the guide member. The method may include an operation of providing an adhesive between the outer surface of the guide member and the inner surface of the receptacle. In addition, the method may include an operation of heating the adhesive above a threshold temperature. Further, the method may include an operation of cooling the adhesive below the threshold temperature after the heating of the adhesive above the threshold temperature. This operation may include the adhesive forming a bond between the guide member and the receptacle. The bond may be reversible above the threshold temperature.

### BRIEF DESCRIPTION OF THE SEVERAL VIEWS OF THE DRAWINGS

FIG. 1 is a side view of an assembly having first and second electronic components in accordance with various embodiments of the present invention.

FIG. 2 is a side view of a second electronic component having a heating system in accordance with an embodiment.

FIG. 3A is a side view with a diagrammatic representation of the receptacle and heating system of FIG. 2 showing a guide member mated with the receptacle.

FIG. 3B is a sectional view of the receptacle and a heating element of FIG. 3A along section AA.

FIG. 4A is a side view with a diagrammatic representation of the receptacle, a guide member, and a heating system according to an alternative embodiment.

FIG. 4B is a sectional view of the guide member and heating system of FIG. 4A along section AB.

FIG. 5 is a side view with a diagrammatic representation of a receptacle and a heating system according to an alternative embodiment.

FIG. 6 is a flow chart of a method according to an embodiment of the present invention.

FIG. 7 is a side view of an assembly having first and second electronic components in accordance with various embodiments of the present invention.

In the drawings and the Detailed Description, like numbers generally refer to like components, parts, steps, and processes.

### DETAILED DESCRIPTION

In the electronics industry, a computer system is often composed of a number of different units coupled together in a final assembly phase. A common manufacturing strategy is to install one or more FRUs on a backplane or motherboard, conduct a test of the system, and then package it for shipping to a customer. It is most desirable to leave the FRUs connected after testing, but vibration during shipping may cause the electrical contacts of any mating components, such as electrical connectors, to rub against each other, causing wear or separation that may result in a connection failure. Aspects of the present invention provide an apparatus and method for securing an FRU in a way that reduces or eliminates movement, and which may, therefore, reduce or eliminate wear of electrical connector materials. An embodiment of the apparatus may be considered a retainer for securing an FRU or a circuit board assembly.

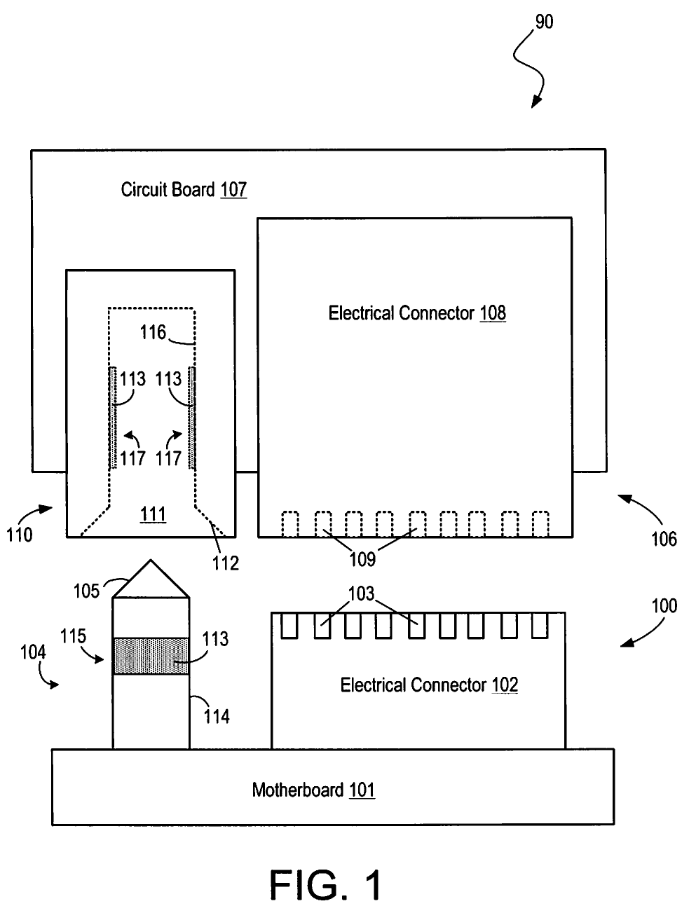

With reference now to FIG. 1, an assembly 90 according to various embodiments of the invention is shown. The assembly 90 may be an element of a computer system such as a mainframe, server, or personal computer. The assembly 90 may include a first electronic component 100 and a second electronic component 106. The first electronic component 100 may include: a circuit board 101, an electrical connector 102 having one or more electrically conductive elements 103, and a guide member 104. The circuit board 101 may include electric circuits, integrated circuits, connectors, sockets, slots, and other electrical and electronic components. The circuit board 101 may be a motherboard, mothercard, backplane, chassis, or any other similar computer system component. In one embodiment, the electrical connector 102 may be a socket, such as a socket for a circuit board, DIMM, or SIMM.

The shown guide member 104 is cylindrical and has a conical tip 105. Other embodiments of the guide member may have members of various shapes and sizes. For example, a guide member may be a rod with three or more flat sides. In addition, a guide member tip may be rounded or flat. In addition, a guide member may be of any suitable length or cross sectional area. In one embodiment, a guide member is 0.75 inches in length and has a cross-sectional area of 0.5 square inches. While only one guide member 104 is shown, two or more guide members may be provided on the first electronic component 100 in alternative embodiments.

The second electronic component 106 may include: a circuit board 107, an electrical connector 108 having one or more electrically conductive elements 109, and a receptacle 110 having an aperture 111 for mating with the guide member 104. The circuit board 107 may be a daughter card, a blade, or any other similar computer system component. The circuit board 107 may include electric circuits, integrated circuits, connectors, sockets, slots, and other electrical and electronic components. In one embodiment, the electrical connector 108 may be adapted for insertion into a socket or other “female” connector, e.g., the electrical connector 108 may include a portion similar to the bottom edge of a DIMM or SIMM. Also, the shown aperture 111 is cylindrical and has a chamfered opening 112. Other embodiments may have an aperture of various shapes and sizes. For example, an aperture may have three or more flat sides. Further, an aperture may be deeper than the length of a guide member. While only one receptacle 110 is shown, two or more receptacles may be provided in alternative embodiments.

Referring still to FIG. 1, a layer of thermally-reversible adhesive 113 may be provided on either an outer surface 114 of the guide member 104, as exemplified by location 115, or on an inner surface 116 of the receptacle 110, as exemplified by location 117, or on both surfaces 114 and 116. The surfaces 114, 116 may have a roughened texture or they may contain grooves or threads to encourage adhesive flow and to strengthen the resulting bond. The cross-sectional area of the aperture 111 may be larger than the cross-sectional area of the guide member 104 by an amount sufficient to accommodate the thermally-reversible adhesive 113 and to facilitate mating.

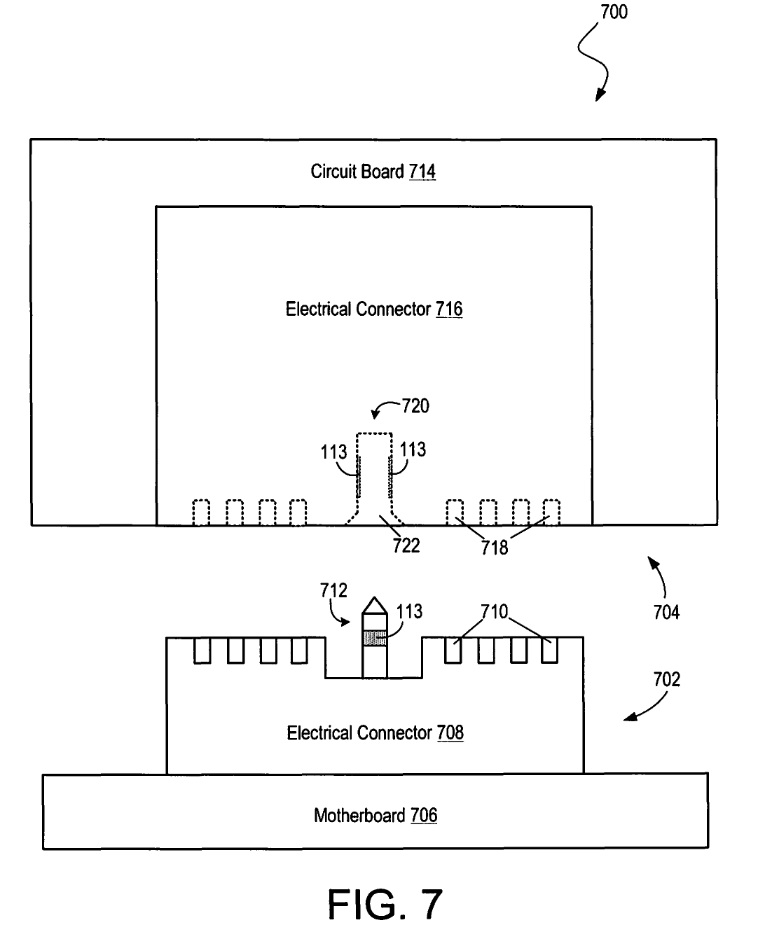

The receptacle 110, guide member 104, and connectors 102, 108 may all be discrete components, and each may be placed within or on the first component 100 or the second component 106 in any suitable location. In some embodiments, the receptacle 110 or guide member 104 may be formed integrally with the circuit board 107 or circuit board 101. Additionally, in some embodiments, the receptacle 110 or guide member 104 may be formed integrally with the connectors 102 or 108 as shown in FIG. 7. Moreover, the first component 100 and second component 106 may include a like number of guide members and guide member receptacles.

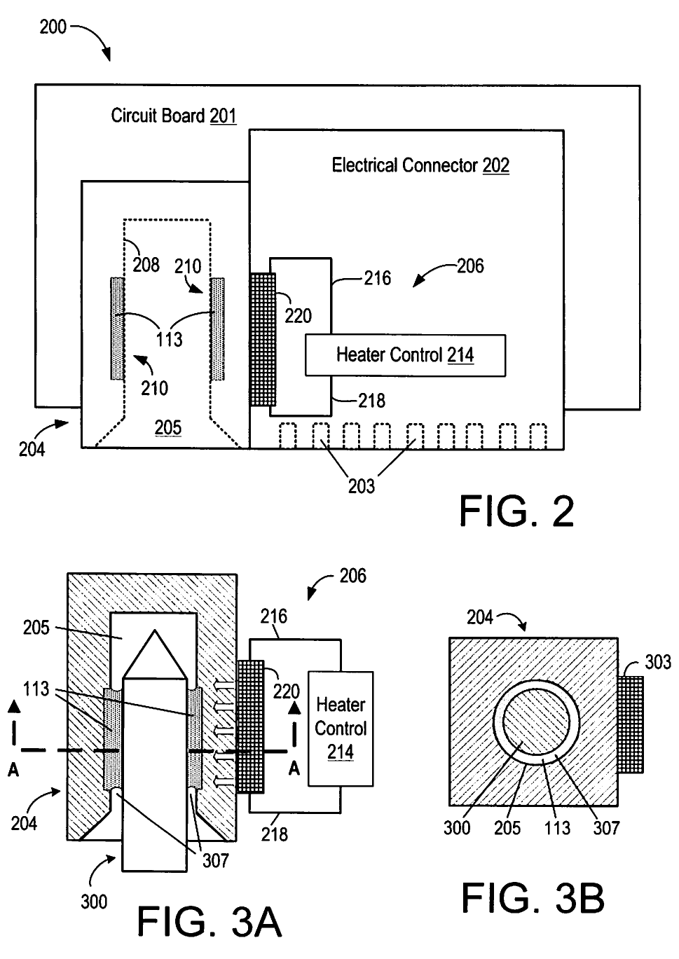

FIG. 2 is a side view of a second electronic component 200 having a receptacle 204 and a heating system 206 according to an embodiment of the invention. In this alternative embodiment, the second component 200 may include: a circuit board 201, an electrical connector 202 having a plurality of electrically conductive elements 203, and a receptacle 204 having an aperture 205 for mating with a guide member. The receptacle 204 includes an interior surface 208 within the aperture 205. The surface 208 may contain one or more reservoirs or depressions where the thermally-reversible adhesive 113 may be provided. As one example, a reservoir or depression may be formed at location 210. Alternatively, a layer of thermally-reversible adhesive 113 may be provided on an outer surface of a guide member (not shown). Moreover, one or more reservoirs or depressions (not shown) may be provided on a guide member for holding thermally-reversible adhesive 113.

The second electronic component 200 may include a heating system 206 having a heater control module 214, wires 216 and 218, and a heating element 220. The assembly 90 may be an element of a computer system and the heater control module 214 may be a circuit communicatively coupled with this computer system. The heater control module 214 may provide power to the heating element 220 upon receiving an activation signal. The activation signal may be generated by the computer system in response to a software or hardware command received from a user. In one alternative, a button or switch may be coupled with the module 214 and the activation signal may be generated in the heater control module 214, such as in response to the button or switch being pushed or moved to a connect position. In one embodiment, the heater control module 214 may receive the activation signal from the first electronic component 100. Additionally, the heater control 214 may receive electric current sufficient to power the heating element 220 from the first electronic component 100. The heater control module 214 may receive the activation signal or the electric current providing power via the electrical connectors 102 and 202, or via a dedicated connector. In one alternative, the heater control module 214 may include an internal power supply, such as a battery.

Any part of the heating system 206, such as the control module 214 or heating element 220 may be placed within or on the first electronic component 100 or the second electronic component 106, 200 in any suitable location. Further, it is not critical that every part of the heating system 206 be provided on the same electronic component. Some parts may be on one electronic component while other parts are on another electronic component. A factor of component location may be that the heating element 220 and the thermally-reversible adhesive 113 are positioned so as to allow thermal communication between them.

As described below, one property of the thermally-reversible adhesive 113 is that when heated, it may melt and flow between one or more surfaces, and when cooled, it may form a bond between the surfaces. In addition, the thermally-reversible adhesive 113 generally permits bonded surfaces to be easily de-bonded at least one time by applying heat to the adhesive. Accordingly, one aspect of the present invention is the ability to bond a guide member, e.g., member 104 and a receptacle, e.g., receptacle 110, by a first heating of the thermally-reversible adhesive 113. An additional aspect is the ability to easily separate the guide member and receptacle one time by re-heating and re-melting the thermally-reversible adhesive 113. In an alternative embodiment, the process of mating and separating the guide member and receptacle may be repeated two or more times. These features may allow a user to remove an FRU and service it, or may allow the user to replace an FRU with a similar component.

FIG. 3A is a side view of the receptacle 204 and heating system 206 of FIG. 2 showing an exemplary guide member 300 mated with the receptacle 204. The heating system 206 may be activated at any desired time after the guide member 300 is seated in the aperture 205. As mentioned, the heating system 206 may be activated in response to receipt of an activation signal by the heater control module 214. In response to the activation signal, the heater control module 214 causes the heating element 220 to receive electric current through wires 216 and 218. When the receptacle 204 is heated above a threshold temperature and the thermally-reversible adhesive 113 is sufficiently heated, the adhesive melts and flows throughout a space 307 between the outer surface of the guide member and the inner surface of the receptacle. The heating system 206 may be deactivated in response to receipt of a deactivation signal by the heater control module 214. The heater control module 214 causes the heating element 220 to stop receiving electric current through wires 216 and 218 in response to the deactivation signal. The heating element 220 may be turned off after it is determined that adhesive has melted and flowed throughout the space 307. The receptacle and adhesive may then be allowed to cool. The adhesive 113 creates a solid bond between the guide member 300 and the receptacle 204 after cooling, thereby holding a first electronic component and a second electronic component immovable with respect to one another when subject to many types of vibrations, such as those typically experienced during the shipping of a computer system.

FIG. 3B is a sectional view of the receptacle and heating element of FIG. 3A along section AA. The guide member 300 is seated in the aperture 205 of the receptacle 204 after the guide member 300 and receptacle 204 have been mated. The thermally-reversible adhesive 113 is shown as a solid bond between the guide member 300 and the receptacle 204, the bond having been formed following the above-described heating and cooling steps.

As mentioned, the assembly 90 may be an element of a computer system and the deactivation signal may be generated by this computer system. The computer system may include a software or hardware timer, and may generate the deactivation signal after a particular time has elapsed. In one alternative, the deactivation signal may be generated in the heater control module 214, such as in response to pushing a button or moving a switch to a disconnect position, the button or switch being coupled with the module. In yet another alternative, a temperature sensor may be provided in a location near the receptacle 204. The temperature sensor may be coupled with a computer system or the heater control module 214. Sensed temperature data may be used to generate a deactivation signal when a particular temperature is sensed.

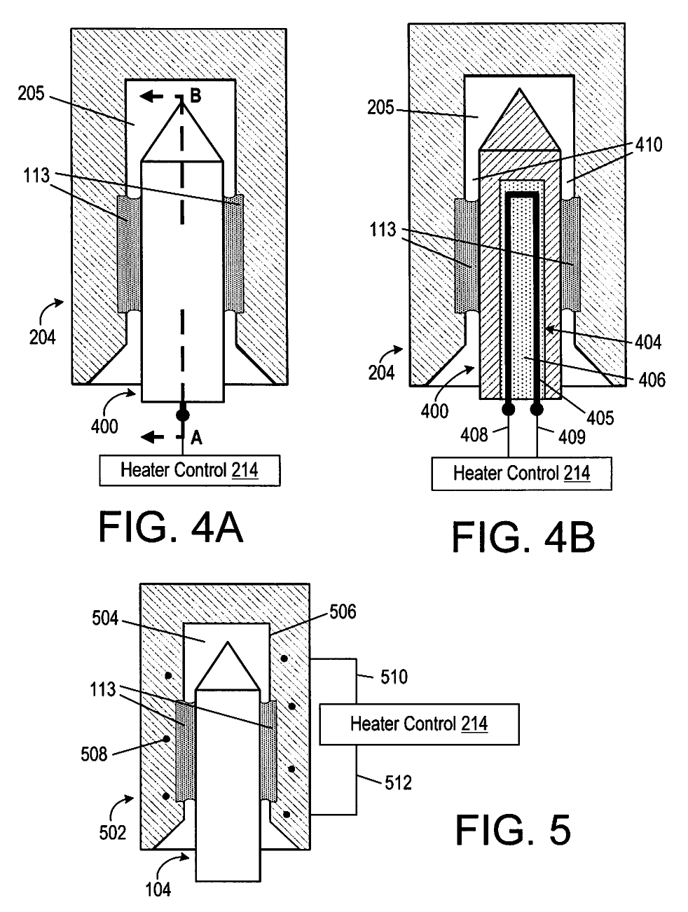

With reference to FIGS. 4A and 4B, an alternative embodiment of a guide member and heating system is shown. FIG. 4A is a side view of a guide member 400, showing the guide member 400 mated with the receptacle 204, and the thermally-reversible adhesive 113. FIG. 4B is a sectional view of the assembly of FIG. 4A along the section AB. The guide member 400 resides in the aperture 205 of the receptacle 204. As shown in FIG. 4B, the guide member 400 may include a cavity 404 for receiving a heating element 405, which may be embedded in a compacted mass 406 of refractory insulating material, such as magnesium oxide. Alternatively, only the heating element 405 may be embedded in the guide member 400 if, for example, the member is made of a material that does not need an electrical insulator between the heating element and the guide member.

When activated, the heater control module 214 transmits an electric current through wires 408 and 409 to the heating element 405 within the guide member 400. The guide member 400 is then heated, which in turn heats the thermally-reversible adhesive 113. The embodiment shown in FIGS. 4A and 4B may be used for any operation described herein that requires heating of the thermally-reversible adhesive 113.

In further aspects of the invention, a guide member according to the principles of the invention may be made from a metal, such as steel, nickel, or aluminum; or may be made from a plastic, such as an acetal.

FIG. 5 is a side view of a receptacle and a heating system according to an alternative embodiment. The receptacle 502 includes an aperture 504. A layer of a thermally-reversible adhesive 113 may be provided on either an outer surface of a guide member or on an inner surface 506 of the receptacle 502, as described herein. In this embodiment, a heating element 508 is provided within the receptacle 502. The heating element 508 is coupled with the heater control module 214 via wires 510, 512. The heating element 508 may be helical, surrounding the aperture 504. In various alternatives, the heating element 508 may be provided within the receptacle 502 on one or more sides of the receptacle or on the end opposite the aperture 504. The heating element 508 may be surrounded entirely by material or structure of the heating element, or may be partially or completely exposed above a surface of the heating element.

The receptacle 502 may be heated, which in turn heats the thermally-reversible adhesive 113. The embodiment shown in FIG. 5 may be used for any operation described herein that requires heating of the thermally-reversible adhesive 113.

In further aspects of the invention, a receptacle according to the principles of the invention, e.g., receptacle 110, 204, or 502, may be made from a metal, such as steel, nickel, or aluminum; or may be made from a plastic, such as an acetal.

In other embodiments of the invention, a heat source that melts a thermally-reversible adhesive may be completely separate from a computer system. For example, the heating of a thermally-reversible adhesive may be done using a heat gun or other external heat source.

The thermally-reversible adhesive 113 has the ability to melt when heated a first time and solidify when cooled a first time forming a strong physical bond, and the ability to dissolve the bond at least once when heated a second time. In addition, the thermally-reversible adhesive 113 may have the ability to repeat the heating and cooling process one or more times without degrading the bond formed when cooled. The thermally-reversible adhesive 113 has a threshold or melting temperature, i.e., a temperature above which the adhesive 113 is a fluid and below which it is solid. The thermally-reversible adhesive 113 may be a hot-melt adhesive, an acetal-based epoxy thermoset, or an acrylic or silicone material employing reversible Diels-Alder crosslinks. The adhesive 113 may either be commercially available, e.g., Jet-melt™ adhesive from 3M (Minnesota Mining and Manufacturing) Company of St. Paul, Minn., or be capable of being tailored to exhibit, for example, a melting temperature between 140° F. (60° C.) (one common system operating temperature) and 455° F. (235° C.) (solder reflow temperature). For example, the adhesive 113 may be a thermoplastic resin having a melting temperature of 264° F. (129° C.), which is generally well above one common system operating temperature but generally well below the solder reflow temperature. In addition, the adhesive 113 may be a hot-melt adhesive having a melting temperature of 385° F. (196° C.), which is also within the above-mentioned exemplary temperature range. In another example, the adhesive 113 may be an acrylic or silicone employing reversible Diels-Alder crosslinks that has been synthesized such that it is crosslinked at all temperatures up to 266° F. (130° C.) at which point a retro Diels-Alder reaction occurs, breaking the crosslinks and rendering the silicone fluid like.

In one alternative, the thermally-reversible adhesive 113 may have a melting temperature below an expected operating temperature of the computer system. For example, the computer system may include a cooling device operable to maintain the receptacle and guide member at temperatures below the generally expected operating temperature of the computer system. As a second example, vibrations of the type typically experienced during the shipping of a computer system may not be expected after installation of the system at a fixed location. As such, an adhesive 113 may have a melting temperature below an expected system operating temperature, provided the melting temperature is above a maximum temperature expected during shipping. In this example, the adhesive 113 may serve to prevent electrical connector wear due to vibration during shipping even though the adhesive may melt during system operation. By way of example, an adhesive 113 may have a melting temperature of 110° F. (43° C.), 120° F. (49° C.), or 130° F. (54° C.), these melting temperatures being above maximum temperatures expected during particular shipping circumstances. In one embodiment, a guide member may be provided with a container or cup at its base for receiving an adhesive having a melting temperature below an expected system operating temperature but above a maximum temperature expected during shipping.

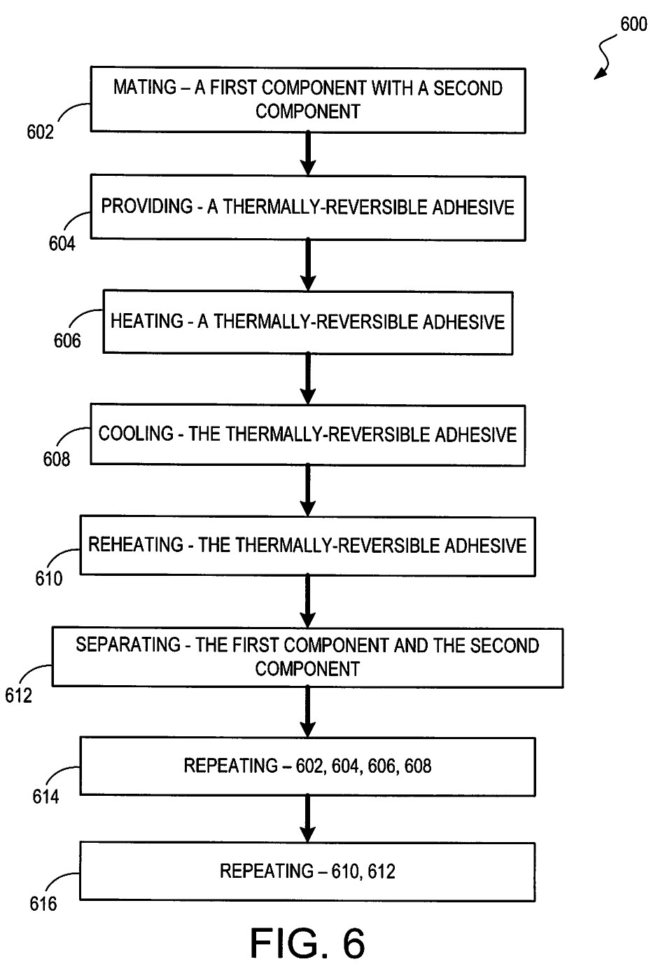

FIG. 6 illustrates a flow chart of a method 600 for securing a first electronic component to a second electronic component according to an embodiment of the invention. The method includes, in operation 602, mating a first electronic component having a first electrical connector and a guide member with a second electronic component having a second electrical connector and a receptacle for the guide member. In operation 604 may include providing an adhesive between the outer surface of the guide member and the inner surface of the receptacle. In operation 606, the thermally-reversible adhesive, e.g., adhesive 113, may be heated until it reaches a temperature above its melting temperature. In operation 608, the thermally-reversible adhesive is cooled until it reaches a temperature below its melting temperature. The operation 604 may be performed after the operation 606. The thermally-reversible adhesive may form a bond between the guide member and receptacle in operation 608. The method 600 may include optional operations 610 and 612 following the operation 608. In operation 610, the thermally-reversible adhesive 113 may be heated above its melting temperature. In operation 612, the first electronic component and second electronic components may be separated.

In one embodiment, the method 600 may include an optional operation 614. The operations 602, 604, 606, and 608 may be repeated. Moreover, the method 600 may include an optional operation 616 in which the operations 610 and 612 may be repeated.

FIG. 7 is a side view of an assembly 700 having first 702 and second 704 electronic components according to an embodiment. The first electronic component 702 may include: a circuit board 706, an electrical connector 708 having one or more electrically conductive elements 710, and a guide member 712. The second electronic component 704 may include: a circuit board 714, an electrical connector 716 having one or more electrically conductive elements 718, and a receptacle 720 having an aperture 722 for mating with the guide member 712. A layer of thermally-reversible adhesive 113 may also be provided. This embodiment is an alternative where the guide member 712 and the receptacle 720 are formed integrally with the connectors 708 or 716. The embodiment shown in FIG. 7 may also include a heating system of the types shown in FIG. 3, 4, or 5, or any similar heating system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An assembly comprising:
a first component having a first electrical connector and a guide member;
a second component having a second electrical connector to couple with the first electrical connector, and a receptacle to receive the guide member in a mated position; and
an adhesive between the guide member and the receptacle when the guide member is in the mated position, the adhesive to form a bond between the guide member and the receptacle, the bond being reversible above a threshold temperature.

2. The assembly of claim 1, further comprising a heating element to heat the adhesive.

3. The assembly of claim 2, wherein the guide member includes the heating element.

4. The assembly of claim 2, wherein the receptacle includes the heating element.

5. The assembly of claim 1, wherein the adhesive is a hot-melt adhesive.

6. The assembly of claim 1, wherein the adhesive is an acetal-based epoxy thermoset.

7. The assembly of claim 1, wherein the adhesive employs Diels-Alder crosslinks.

8. The assembly of claim 1, wherein the threshold temperature is above a common computer system operating temperature and below a common solder reflow temperature.

9. A retainer for a circuit board assembly, comprising:
a first circuit board having a guide member;
a second circuit board having a receptacle, the receptacle to receive the guide member;
an adhesive between a surface of the guide member and a surface of the receptacle; and
a heating element in thermal communication with the adhesive.

10. The retainer of claim 9, further comprising a first electrical connector, and a second electrical connector to couple with the first electrical connector.

11. The retainer of claim 9, wherein the adhesive is a thermally-reversible adhesive.

12. The retainer of claim 9, wherein the heating element is activated in response to a signal provided by the first circuit board.

13. A method comprising:
mating a first component having a first electrical connector and a guide member with a second component having a second electrical connector and a receptacle to receive the guide member;
providing an adhesive between an outer surface of the guide member and an inner surface of the receptacle;
heating the adhesive above a threshold temperature; and
cooling the adhesive below the threshold temperature after the heating of the adhesive above the threshold temperature, the adhesive forming a bond between the guide member and the receptacle, the bond being reversible above the threshold temperature.

14. The method of claim 13, further comprising heating the adhesive above the threshold temperature after the cooling of the adhesive below the threshold temperature, thereby reversing the bond between the guide member and the receptacle.

15. The method of claim 13, further comprising providing a heating element.

16. The method of claim 15, wherein the guide member includes the heating element.

17. The method of claim 15, wherein the receptacle includes the heating element.

18. The method of claim 13, wherein the adhesive is a hot-melt adhesive.

19. The method of claim 13, wherein the adhesive is an acetal-based epoxy thermoset.

20. The method of claim 13, wherein the adhesive is a silicone employing Diels-Alder crosslinks.
